(19) United States
(12) Patent Application Publication
(10) Pub. No.: US 2009/0202849 A1
(43) Pub. Date: Aug. 13, 2009

(54) COATING OF A MAGNESIUM COMPONENT

(75) Inventors: Nico Scharnagl, Buchen (DE); Carsten Blawert, Lauenburg (DE)

Correspondence Address: MICHAUD-DUFFY GROUP LLP, 306 INDUSTRIAL PARK ROAD, SUITE 206, MIDDLETOWN, CT, 06457, US

(73) Assignee: GKKS-FORSCHUNGSZENTRUM GEESTHACHT GMBH, Geesthacht (DE)

(21) Appl. No.: 12/370,017

(22) Filed: Feb. 12, 2009

(30) Foreign Application Priority Data
Feb. 13, 2008 (DE) 102008009069.7

(51) Int. Cl. B32B 15/08; B05D 3/00

(52) U.S. Cl. 428/458; 427/388.1; 427/327; 427/373; 427/2.1

(57) ABSTRACT

A part containing magnesium is coated by wetting the part with a polymer solution that contains polyetherimide and a solvent to provide a wetted part; and drying the wetted part to form a coating layer on the part. The corrosion rate of a biocomponent made of magnesium or a magnesium alloy is controlled by forming a coating layer on the biocomponent according to a method described herein, wherein the coating layer has a porosity that provides a corresponding corrosion rate.

### CROSS-REFERENCE TO RELATED APPLICATION

This application claims the benefit of German patent application DE 10 2008 009 069.7 filed Feb. 13, 2008, which is incorporated herein by reference.

### FIELD OF THE INVENTION

The invention relates to a method for the treatment of a part made of magnesium or a magnesium alloy as well as a use of a polymer solution for treatment of the part.

### BACKGROUND

It is known that magnesium and its alloys are light, base metallic construction materials. Therefore magnesium and the alloys are very prone to contact corrosion.

The corrosion properties of magnesium and/or magnesium surfaces can be modified by conversion coatings and/or reaction layers and by inorganic or organic coatings. For example, in processes in which anodic oxidation of a substrate surface occurs in an electrolyte plasma, solid, dense layers made of magnesium oxides and/or magnesium phosphates are produced with an electrical insulating effect and good abrasion resistance. However, these layers generally also require sealing by an organic coating (top coat) to ensure long-term corrosion protection. Furthermore, these processes are generally comparatively expensive.

Magnesium has good corrosion resistance in air, but it is not stable in solutions containing chloride, sulfate, carbonate and nitrate. Only at pH values above 11 do magnesium alloys form stable cover layers, so that for the technically relevant pH range from 4.5 to 8.5, in which aluminum, for example, forms stable cover layers, no effective protective layers exist which are self-healing if damaged.

Furthermore, magnesium is the most base construction material, so that on one hand it has a tendency to considerable disintegration as a result of microgalvanic corrosion, especially caused by impurities containing Fe, Ni and Co, and on the other hand with magnesium alloys, internal galvanic corrosion is caused by a second phase which is less base, or by inclusions. Since magnesium is often used in conjunction with materials which are less base, coating of the components is essential to prevent contact corrosion with applications in aggressive media and/or in the presence of water.

The corrosion and wear properties of magnesium surfaces can, depending on the use and application, be modified by conversion layers and/or reaction layers and by inorganic or even organic coatings.

In US 2006/0063872 A1, EP 0 949 353 B1, US 2005/0067057 A1, U.S. Pat. No. 4,973,393, U.S. Pat. No. 5,993,567, WO 99/02759 A1, and DE 199 13 242 C2 numerous methods or measures for the corrosion protection of magnesium and its allies are described.

### SUMMARY

The present invention resides in one aspect in a method for coating a part comprising magnesium, the method comprising wetting the part with a polymer solution that comprises polyetherimide and a solvent to provide a wetted part; and drying the wetted part to form a coating layer on the part.

The present invention resides in another aspect in a part comprising a body member that comprises magnesium or a magnesium alloy and a coating layer formed on the body member by a method described herein.

Still another aspect of the present invention resides in a method for controlling of the corrosion rate of a biocomponent made of magnesium or a magnesium alloy. The method comprises forming a coating layer on the biocomponent according to a method described herein, wherein the coating layer has a porosity that provides a corresponding corrosion rate.

### DETAILED DESCRIPTION OF THE INVENTION

The present invention provides, in various embodiments, an inexpensive and simple corrosion resistant, non-toxic coating layer for parts comprising magnesium, that is, parts made of magnesium or magnesium alloys, which includes parts having surfaces containing magnesium, and a method of forming the coating layer on the surface of such parts. Such a coating layer may be formed on at least one surface of the part by wetting the surface with a polymer solution which contains polyetherimide and a solvent. The part may be wetted with the solution in any desired manner, for example, by spraying the solution onto the part, or by immersing the part into the polymer solution, etc. Drying the part, for example, upon removing the part from the polymer solution, leads to the formation of a coating layer on the part. The coating layer may be corrosion resistant, dense, and non-porous, or the coating layer may be substantially free of pores, or the coating layer may be corrosion resistant and porous, depending on the solvent used in the solution. The porosity may vary with the fraction and/or type of the solvent in the polymer solution.

A porous, microporous or non-porous coating layer on components or parts made of magnesium will be formed on the surface of the component or part by a polymer solution containing polyetherimide and a solvent, depending on the type of the solvent and/or the fraction in the polymer solution. The method of applying the coating layer is a simple coating process which involves less effort and is also less expensive than other methods. The components and/or parts are preferably manufactured from a magnesium material, so that the coating layer formed thereon provides blood-compatible, stable, stress-resistant corrosion protection for the part.

The application of a coating layer made of polyetherimide on the part provides stable corrosion protection of the part's surface, long-term stability and compatibility with blood. The resistant polymer layer passivates or protects the parts against mechanical and corrosive attacks. In particular, the introduction of water and other corrosion-promoting or corrosively acting substances to the surface of the part is considerably reduced or prevented.

In general, no or only low amounts of environmentally harmful substances are produced during coating.

Various polyetherimides may be used to form the corrosion resistant coating layers on a part as described herein. In some embodiments, the polymer solution contains multiple, different polyetherimides. Example polyetherimides that are suitable for use in the present invention are known under the designations “ULTEM” (from General Electric) or “RAU-PEI” from Rehau, however, the invention is not limited in this regard, and in other embodiments, other polyetherimides may be used singly or in combination.

Optionally, a polyetherimide coating layer may be applied onto a part that already has one or more pre-existing protective layers thereon. In one embodiment, the polyetherimide coating layer reduces the porosity of the coating on the part, by sealing the pre-existing protective layers.

In another embodiment, a part that already has a corrosion-resistant coating but which has exposed surface damage nonetheless can be easily repaired by applying a polyetherimide polymer solution to the part's surface, for example by immersion in a polymer solution or by spraying on the polymer solution.

A polyetherimide coating layer applied onto a part as described herein exhibits good adhesion on the magnesium part and/or on its surface. The quality of the coating layer is controlled by the choice of a corresponding composition of the polymer solution and the choice of the coating method.

The porosity of the polyetherimide coating layer is dependent on the choice of solvent and/or its properties and its concentration in the polymer solution. For example, a solution of a solvent which is not miscible with water, such as dichloromethane, and a high concentration of polyetherimide, for example greater than about 3 weight percent, provided a coating layer on the part with low or no porosity, so that low rates of corrosion are achieved. By applying the polyetherimide coating layer(s) to parts as described herein, the corrosion or corrosion rates of the parts can be set or monitored in a targeted manner.

Preferably a part comprising magnesium or a magnesium alloy coated according to the invention has a corrosion rate less than about 1.0 mm per year, for example, less than 0.9 or 0.8 mm per year, measured by a salt spray test as per DIN 50021.

In contrast to this, a coating layer with a solution made of solvents miscible with water and a low concentration of the polyetherimide, such as less than about 10 weight percent, leads to a high and/or increased porosity and thus to a higher corrosion rate compared to the non-porous coating layer.

In some embodiments, a corrosion resistant polyetherimide coating layer provided as described herein for magnesium or magnesium alloy parts can facilitate a subsequent chemical modification of the part surface by suitable reagents or methods. The surface modification of the part, for example by chemical reactions or plasma treatment, etc., may provide improved blood compatibility in a medical application of the part, for example as an implant.

In various embodiments of the coating method described herein, a part is immersed in the polymer solution or sprayed with the polymer solution, so that the surface of the part is wetted with the polymer solution. In one optional embodiment, the surface of the part is cleaned prior to coating, but in an alternative embodiment, the surface of the part to be coated is not cleaned prior to coating. The thickness of the coating layer on the surface of a part having a first coating layer thereon may be increased by applying a polyetherimide second coating layer onto the part by the method described herein. By repeating the coating method, the coating layer thickness on the surface of the part is gradually increased.

According to still another embodiment, the surface of a part is pre-treated before the part is coated, for example, the part may be furnished with a conversion coating layer or a bond coat before the part is wetted with the polyetherimide polymer solution. Pre-treating the component surface results in improved properties of the component surface to be coated due to the conversion coating layers or bond coats achieved or formed on the part. The term “conversion coating layer” is understood, for example, to mean a layer formed by chemical transformation (conversion) of the metallic surface and different constituents of electrolytes or similar materials. A bond coat applied to the component surface improves the adhesion of the subsequently applied corrosion resistant layer and/or corrosion layer. Within the scope of the invention, a conversion coating layer can be identical to a bond coat.

In a particular embodiment, the polymer solution comprises a solvent which is miscible with water, so that a porous coating layer is formed on the part. Porous coating layers can be formed on the part when the concentration of polyetherimide in the polymer solution is, for example, less than 10 weight percent.

Solvents that are suitable for use in the present invention and which are miscible with water include dimethyl acetamide (DMAc) and/or dimethyl formamide (DMF) and/or N-methyl pyrrolidone (NMP) and/or gamma butyrolactone (GBL), however, the invention is not limited in this regard, and in other embodiments, other water-miscible solvents may be employed.

According to an alternative embodiment, a solvent is used which is not miscible with water, so that a dense, pore-free coating layer is formed on the part. Suitable water-immiscible solvents include dichloromethane and/or chloroform and/or 1,2-dichloroethane, however, the invention is not limited in this regard, and in other embodiments, other water-immiscible solvents ma be used.

According to one embodiment, the concentration of polyetherimide in the polymer solution is about 0.5 weight percent to about 20 weight percent.

In specific embodiments, the coating layer is a porous coating layer in which the diameters of the pores is about 10 nm to about 10 μm. In one illustrative embodiment, the diameter of pores in the coating layer is about 2 μm.

In certain embodiments, the coating layer on the part is formed in such a way that the part is corrosion resistant due to the coating layer, or such that the part remains protected against corrosion at the point of action of the mechanical application of a force on the part, such that the damaged point remains unchanged with respect to corrosion due to the applied coating layer. With a mechanical application of force on the surface, if damage occurs, the applied coating layer may also be adversely affected and/or damaged, but nonetheless the damaged point continues to remain protected against corrosion, and at the damaged point as well the low corrosion rate is retained due to the coating layer.

In an optional embodiment, the polymer solution is applied or deposited and subsequently dried on the surface of a part having a defective corrosion layer thereon, so that the defective point of the defective corrosion layer is supplied with another coating layer as described herein. In this way, a simple, fast and effective repair of defects or damaged places on the part surface is possible.

In certain embodiments, a coating layer as described herein and having a particular thickness adheres more strongly to the part than a coating layer of the same thickness made of acrylate. Experiments have shown that the applied polyetherimide coating layer has strong adhesion on the magnesium surface of the part, which is believed to help the part remain resistant to corrosion even when the part is subject to a mechanical stress on the part surface. The coating layer remains on the surface of the part despite the mechanical stresses.

In various specific embodiments, the polymer solution contains particles or inhibitors or therapeutic or medicinal active substances, so that particles or inhibitors or therapeutic or medicinal active substances are included or introduced in or applied to the coating layer. This yields a series of numerous applications for a coated part, for example in medical technology as an implant or as a vascular support device.

One aspect of the present invention provides for the use of a polymer solution for the treatment of a part made of magnesium or a magnesium alloy, for coating or optionally repairing a surface of a part made of magnesium or a magnesium alloy, in which the previously described method is carried out using the polymer solution which contains polyetherimide and a solvent. Depending on the solvent as well as its type and properties, a corrosion resistant, dense, non-porous coating layer or a porous coating layer is formed on the surface of the part.

Depending on the concentration of the polymer in the solution and also on the dwell time of the part in the polymer solution during treatment, a predetermined layer thickness of the applied coating layer can be achieved. In particular, the thickness of the coating layer may be about 1 μm to about 100 μm to provide particularly high corrosion resistance. In some experiments, a single immersion of a part in a two-percent dichloromethane solution yielded a 5 μm coating layer thickness, while with multiple immersions a multiple of the coating layer thickness was achieved.

In the experiments, parts were wetted by immersing the parts in the polymer solution; in a subsequent step the wetted parts were dried, for example, the solvent was evaporated in air or in a vacuum chamber. In this way the protective polymer coating layer was formed on the surface of the part. With the coating of magnesium samples it was found that the samples had significantly increased corrosion resistance compared to untreated samples. In particular, an effect of corrosion protection for the coated part was seen to remain constant, even with changes in climate and chloride exposure (such as salt spray tests, etc.) even after a number of days (30 days).

Furthermore, a method is provided for the control of the corrosion rate of a biocomponent, such as self-dissolving biocomponents (such as implants), made of magnesium or a magnesium alloy, by the application of a coating layer onto the biocomponent as described herein. The corrosion rate, e.g., the rate of self-dissolving, is controlled by the controlling the porosity of the preferably self-dissolving biocomponent. In one embodiment, a coating layer is applied that provides a predetermined, defined corrosion rate, in particular of less than 1.0 mm per year for a pure magnesium alloy, measured by means of a salt spray test as per DIN 50021, so that the implanted biocomponent in a human body dissolves itself after the healing of a fracture, for example.

In certain embodiments, this invention relates to a method for the treatment of a part made of magnesium or a magnesium alloy, as well as a use of a polymer solution for the treatment of a part, especially for coating a part made of magnesium or a magnesium alloy. The method may be characterized in that the part is wetted with a polymer solution, and that the polymer solution contains polyetherimide and a solvent. After drying of the part, a corrosion resistant, dense, non-porous coating layer, or a coating layer free of pores, or a corrosion resistant, porous coating layer, is formed on the surface of the part, depending on the solvent in the polymer solution, particularly the fraction and/or type of the solvent.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced item.

Although the invention has been described with reference to particular embodiments thereof, it will be understood by one of ordinary skill in the art, upon a reading and understanding of the foregoing disclosure, that numerous variations and alterations to the disclosed embodiments will fall within the scope of this invention and of the appended claims.

What is claimed is:

1. A method for coating a part comprising magnesium, the method comprising:
wetting the part with a polymer solution that comprises polyetherimide and a solvent to provide a wetted part; and
drying the wetted part to form a coating layer on the part.

2. A method according to claim 1, comprising immersing the part in the polymer solution or spraying the part with the polymer solution.

3. A method according to claim 1, comprising cleaning the part before wetting the part with the polymer solution.

4. A method according to claim 1, comprising wetting the part with the polymer solution without first cleaning the part.

5. A method according to claim 1, wherein the part comprises a conversion coating layer or a bond coat before being wetted with the polymer solution.

6. A method according to claim 1, wherein the solvent is miscible with water.

7. A method according to claim 1, wherein the solvent comprises dimethyl acetamide (DMAc), dimethyl formamide (DMF), N-methyl pyrrolidone (NMP), gamma butyrolactone (GBL), or a combination of any two or more thereof.

8. A method according to claim 1, wherein the solvent is not miscible with water.

9. A method according to claim 1, wherein the solvent comprises dichloromethane, chloroform, 1,2-dichloroethane, or a combination of any two or more thereof.

10. A method according to claim 1, wherein the concentration of polyetherimide in the polymer solution is about 0.5 to about 20 weight percent.

11. A method according to claim 1, wherein the coat comprises pores having diameters of about 10 nm to about 10 μm.

12. A method according to claim 1, wherein the coat comprises pores having diameters of about 2 μm.

13. A method according to claim 1, wherein the part comprises a corrosion layer having a defect and the method comprises forming the coat over the defect.

14. A method according to claim 1, wherein the coat has a thickness and adheres to the part more strongly than a coating layer made of acrylate and having the same thickness.

15. A method according to claim 1, characterized in that the polymer solution contains particles, inhibitors, therapeutic or medicinal active substances, or a combination of any two or more thereof.

16. A part comprising a body member that comprises magnesium or a magnesium alloy and a coating layer formed on the body member by the method of claim 1.

17. A method for controlling of the corrosion rate of a biocomponent made of magnesium or a magnesium alloy, comprising forming a coating layer on the biocomponent according to the method of claim 1, wherein the coating layer has a porosity that provides a corresponding corrosion rate.
